(19) United States
(12) Patent Application Publication
(10) Pub. No.: US 2025/0061157 A1
(43) Pub. Date: Feb. 20, 2025

(54) BOOK RECOMMENDATION METHOD AND APPARATUS, ELECTRONIC DEVICE, AND STORAGE MEDIUM

(71) Applicant: Beijing Bytedance Network Technology Co., Ltd., Beijing (CN)

(72) Inventor: Yifan TAN, Beijing (CN)

(21) Appl. No.: 18/721,157

(22) PCT Filed: Feb. 10, 2023
(86) PCT No.: PCT/CN2023/075500

§ 371 Date: Jun. 17, 2024

(30) Foreign Application Priority Data
Feb. 25, 2022 (CN) 202210178573.8

(51) Int. Cl. G06F 16/9535

(52) U.S. Cl. CPC G06F 16/9535

(57) ABSTRACT

There are provided a book recommendation method and apparatus, an electronic device and a storage medium. The method includes: displaying at least one first book identification corresponding to at least one recommended book within a target page related to a current topic, wherein the recommended book is associated with the current topic; determining a target book identification according to a predetermined rule or in response to a triggering operation acting on any one of the first book identifications; and determining at least one piece of relevant information related to a recommended book corresponding to the target book identification, and displaying at least part of the relevant information in the target page.

### CROSS REFERENCE TO RELATED APPLICATIONS

This application claims priority to Chinese Patent Application No. 202210178573.8, filed on Feb. 25, 2022, entitled “BOOK RECOMMENDATION METHOD, APPARATUS, ELECTRONIC DEVICE, AND STORAGE MEDIUM’, the disclosure of which is incorporated herein by reference in its entirety.

### FIELD

The present application relates to the field of computer technology, and in particular, to a book recommendation method and apparatus, an electronic device, and a storage medium.

### BACKGROUND

In a book reading scenario, a user may obtain book information by means of interaction, for example, an interested book may be found in a book review, an interaction topic, an interaction community, and the like. The interaction topic can aggregate a certain number of users having similar reading requirements, and provide the users with topic activities such as book recommendation and book review, so that the users can obtain book information.

However, in the related art, books recommended by a user within a topic are often simply listed and displayed within the topic, and there is less relevant information about books provided to the user, so that the efficiency of the user in searching for books is low.

### SUMMARY

The purpose of the present application is to provide a book recommendation method and apparatus, an electronic device and a storage medium.

Based on the above purpose, the present application provides a method for recommending a book, including:
displaying at least one first book identification corresponding to at least one recommended book within a target page related to a current topic, wherein the recommended book is associated with the current topic;
determining a target book identification according to a predetermined rule or in response to a triggering operation acting on any of the first book identifications; and
determining at least one piece of relevant information related to a recommended book corresponding to the target book identification, and displaying at least part of the relevant information in the target page.

In some embodiments, the target page is a first page corresponding to the current topic, and the first page is configured for displaying content information comprised in the current topic; displaying at least part of the relevant information in the target page includes: displaying at least part of the relevant information within a predetermined area of the first page.

In some embodiments, the current topic corresponds to a first page for displaying content information comprised in the current topic; the target page is a second page displayed independently of the first page; displaying the at least one first book identification corresponding to the at least one recommended book within the target page related to the current topic, including: displaying the first page, the first page comprising a book recommendation bar; in response to a first triggering operation acting on the book recommendation bar, displaying the second page; and displaying the at least one first book identification corresponding to the at least one recommended book in the second page.

In some embodiments, determining at least one piece of relevant information related to a recommended book corresponding to the target book identification comprises: determining, from the content information comprised in the current topic, at least one piece of target content information associated with the recommended book corresponding to the target book identification, and using the target content information as the relevant information.

In some embodiments, determining at least one piece of the relevant information related to the recommended book corresponding to the target book identification further includes: obtaining at least one of the following as the relevant information: content information associated with the recommended book corresponding to the target book identification within other topics; an excerpt fragment of the recommended book corresponding to the target book identification; book review information of the recommended book corresponding to the target book identification; and recommendation information of the recommended book corresponding to the target book identification.

In some embodiments, at least part of the content information carries a second book identification; the method further includes determining the recommended book by determining at least one book to be selected according to the second book identification; determining a relevance between the book to be selected and the current topic; and determining the recommended book according to the relevance.

In some embodiments, determining, from the content information comprised in the current topic, at least one piece of target content information associated with the recommended book corresponding to the target book identification includes: for any one piece of the content information, in response to determining that any of the second book identifications carried in the piece of content information is in consistent with the target book identification, determining the piece of content information as the target content information.

In some embodiments, displaying a first page corresponding to the current topic includes:
for any one piece of the content information, in response to determining that the number of the second book identifications carried in the piece of content information is one, displaying a cover thumbnail, a title and relevant information of a recommended book corresponding to the second book identification; wherein the relevant information comprises at least one of the following: a category, a rating, a serialization status and the number of readers of the recommended book corresponding to the second book identification; and
for any one piece of the content information, in response to determining that the number of second book identifications carried in the piece of content information is greater than one, displaying cover thumbnails and titles of recommended books corresponding to the second book identifications.

In some embodiments, at least part of the target content information carries a topic jumping identification; and the topic jumping identification is configured to jump, upon being triggered, to a target topic in which a user publishing the target content information participates.

In some embodiments, the target page is further displayed with a reading button; and the reading button is configured to jump, upon being triggered, to a reading page or a transaction page of the recommended book corresponding to the target book identification.

Based on the same technical concept, the present application also provides an apparatus for recommending a book, including:

a first display module configured to display at least one first book identification corresponding to at least one recommended book within a target page related to a current topic, wherein the recommended book is associated with the current topic;

a determining module configured to determine a target book identification according to a predetermined rule or in response to a triggering operation acting on any of the first book identifications; and

a second display module configured to determine at least one piece of relevant information related to a recommended book corresponding to the target book identification, and display at least part of the relevant information in the target page.

Based on the same technical concept, the present application also provides an electronic device, including a memory, a processor and a computer program stored on the memory and executable on the processor, wherein when executing the program, the processor implements the above-described method.

Based on the same technical concept, the present application further provides a non-transitory computer readable storage medium. The non-transitory computer readable storage medium stores a computer instruction, wherein the computer instruction is configured to cause a computer to execute the method in any of the above.

It can be seen from the above description that, in the book recommendation method and apparatus, the electronic device and the storage medium provided by the present application, relevant information associated with a recommended book is displayed in a target page related to a current topic, so that a user can quickly and conveniently know content associated with the recommended book through the displayed relevant information. Thus, the method of the present application can provide more relevant information about books to a user, which effectively improves the efficiency of the user in searching for books.

### BRIEF DESCRIPTION OF THE DRAWINGS

In order to more clearly illustrate the technical solutions in the embodiments of the present disclosures or prior art, the following will be a brief introduction to the accompanying drawings required for the description of the embodiments or the prior art. Obviously the accompanying drawings in the following description relate to some embodiments of the present disclosure. For those of ordinary skill in the art, other drawings can be obtained according to these drawings without creative labor.

FIG. 1 is a schematic diagram of an application scenario according to an embodiment of the present application;

FIG. 2 is a schematic flowchart of a book recommendation method according to an embodiment of the present application;

FIG. 3 is a schematic flowchart of a method for recommending a book according to another embodiment of the present application;

FIG. 4 is a specific exemplary diagram of a first page according to an embodiment of the present application;

FIG. 5 is a specific exemplary diagram of a second page according to an embodiment of the present application;

FIG. 6 is another specific exemplary diagram of a first page according to an embodiment of the present application;

FIG. 7 is yet another specific exemplary diagram of a first page according to an embodiment of the present application;

FIG. 8 is another specific exemplary diagram of a second page according to an embodiment of the present application;

FIG. 9 is a schematic structural diagram of a book recommendation apparatus according to an embodiment of the present application;

FIG. 10 is a schematic structural diagram of an electronic device according to an embodiment of the present application.

### DETAILED DESCRIPTION

In order to make objects, technical solutions and advantages of the present application more apparent, the present application will be further described in detail below in conjunction with specific embodiments and with reference to the accompanying drawings.

The principles and spirit of the present application will be described below with reference to the exemplary embodiments. It should be understood that these embodiments are provided merely to enable those skilled in the art to better understand and further implement the present application, but not to limit the scope of the present application in any way. Rather, these embodiments are provided so that this disclosure will be thorough and complete, and the scope of the disclosure will be fully conveyed to those skilled in the art.

According to embodiments of the present application, a book recommendation method and apparatus, an electronic device, and a storage medium are provided.

In this document, it should be understood that any number of elements in the drawings is used as an example instead of a limitation, and that any name is only used for distinguishing, which has no limiting meaning.

The principle and spirit of the present application are explained in detail below with reference to several representative embodiments of the present application.

In a book reading scenario of the related art, a user may participate in an interactive topic to join topic activities such as book recommendation and book review. Within the topic page, some books related to the topic will be displayed to the user to recommend the user to read. However, in the related art, there is generally a problem that there is less relevant information about books provided to the user, so that the efficiency of the user in searching for books is low.

During the implementation of the present application, the applicant finds that the above-described problem exists because: in the related art, due to the limitation of the display area, only the most basic information (which may generally be a cover thumbnail or a title) of a recommended book is generally displayed in a topic page, less relevant information about the book can be displayed, and thus the user cannot obtain other relevant information. In absence of more relevant information of the book, the user has to directly enter the reading page of the book for reading, but the book is likely to be inconsistent with the reading demand of the user, resulting in in the problem in the related art that the efficiency of performing book recommendation within a topic is relatively low.

In order to solve the above problem, the present application provides a book recommendation solution. A first book identification corresponding to a recommended book is displayed in a target page related to a current topic. When the user triggers the first book identification, relevant information related to the recommended book can be displayed in the target page. In the solution of the present application, related information associated with a recommended book is displayed in a target page related to a current topic, so that a user can quickly and conveniently know the content associated with the recommended book through the displayed related information. The method of the present application can provide more relevant information of a book to a user, which effectively improves the efficiency of the user in searching for a book.

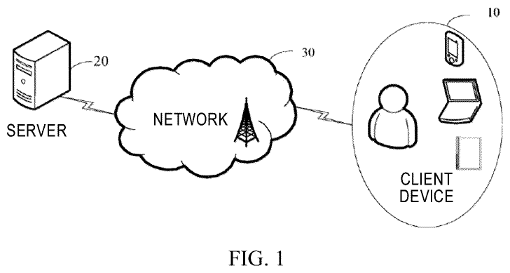

Referring to FIG. 1, FIG. 1 is a schematic diagram of an application scenario of a book recommendation method according to an embodiment of the present application. The application scenario includes a client device 10 and a server 20. The client device 10 may be connected to the server 20 through a network 30 to implement data interaction.

Optionally, the client device 10 may be an electronic device having data transmission and multimedia input/output functions near a user side, such as a computer, a tablet computer, a smart phone, a vehicle-mounted computer, and a wearable device, etc. The electronic device may include a processor and a display screen, wherein the display screen is configured for presenting a graphical user interface, and the graphical user interface may be a topic page in a book reading application; the processor is configured for processing relevant data in the book reading application, generating a graphical user interface, and controlling the display of the graphical user interface on the display screen.

Optionally, the server 20 may be an independent physical server, or the server 20 may also be a server cluster or a distributed system constituted of a plurality of physical servers, or the server 20 may also be a cloud server that provides basic cloud computing services such as a cloud service, cloud database, cloud computing, cloud function, cloud storage, network service, cloud communication, middleware service, domain title service, security services, CDN, and big data and artificial intelligence platforms. The server 20 may provide data storage and data processing support for the operation of the book reading application at the user side. Relevant data of all registered users in the book reading application may be stored in the server 20, and sent to the client device 10 according to calling of the client device 10. When a data processing demand is generated in the book reading application, data to be processed may also be sent to the server 20, and the server 20 returns a result to the client device 10 after processing.

A book recommendation method according to an exemplary embodiment of the present application will be described below with reference to the application scenario of FIG. 1. It should be noted that the foregoing application scenarios are merely shown for facilitating understanding of the spirit and principle of the present application, and the implementations of the present application are not limited in this aspect. Rather, the implementations of the present application may be applied to any scenario where it is applicable.

Firstly, an embodiment of the present application provides a book recommendation method.

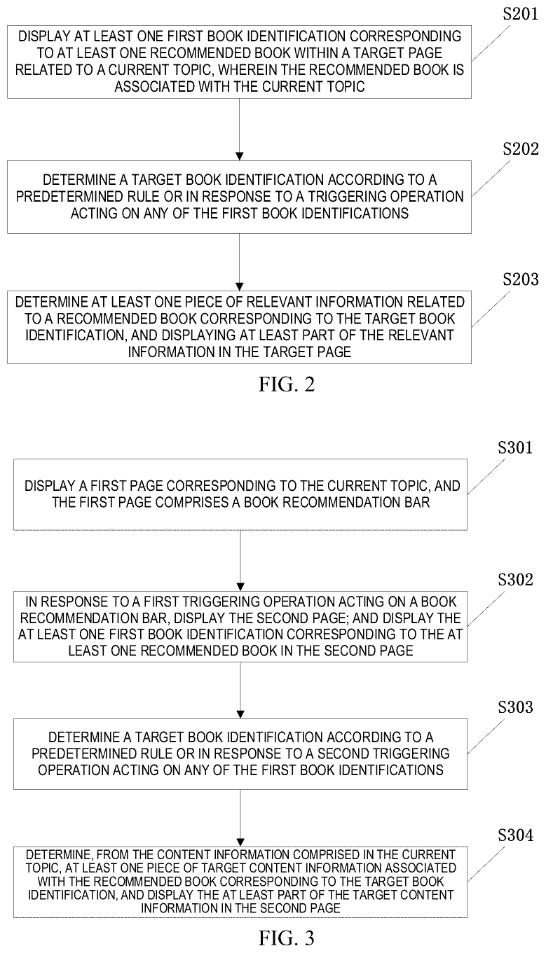

Referring to FIG. 2, the book recommendation method according to this embodiment may include the following steps:

Step S201, displaying at least one first book identification corresponding to at least one recommended book within a target page related to a current topic, wherein the recommended book is associated with the current topic;

Step S202: determining a target book identification according to a predetermined rule or in response to a triggering operation acting on any of the first book identifications; and

Step S203: determining at least one piece of relevant information related to a recommended book corresponding to the target book identification, and displaying at least part of the relevant information in the target page.

In the present embodiment, the target page related to the current topic may be an interface for displaying content information comprised in the current topic, or may be a separate page other than the above interface for displaying content information comprised in the current topic.

Optionally, the interface for displaying content information comprised in the current topic is referred to as a first page in this embodiment; the content information refers to posts, reply content, discussion content, etc. published in the topic by respective users in the current topic. In the first page, at least one first book identification corresponding to at least one recommended book is displayed. Each of the first book identifications corresponds to a recommended book.

The recommended book may be determined by any relevant recommendation algorithm, which is not specifically limited in the embodiments of the present application. For example, a recommended book may be determined by extracting text features from a title of a book and a subject of the current topic and determining a similarity degree between the extracted text features. For example, a book and a topic in a book reading application generally have a predetermined label, and the content thereof is roughly represented by the label (for example, a science fiction book will be provided with a label with content of “science fiction”), and when determining a recommended book, the book may be matched with the label with the current topic, and the book matched with the label is taken as the recommended book.

In this embodiment, the first book identification is configured for showing the relevant information of the recommended book and is capable of being interacted with the user. A target book identification may be determined from several first book identifications according to a predetermined rule or in response to a triggering operation acting on any of the first book identifications. Subsequently, at least one piece of relevant information related to a recommended book corresponding to the target book identification is determined, and at least part of the relevant information is displayed within a predetermined area of the first page. The relevant information records relevant content of the recommended book corresponding to the target book identification, which can assist the user in conveniently and quickly understanding the recommended book, so as to determine whether the recommended book meets his/her reading requirement. In a specific implementation, the relevant information may be relevant content information of a recommended book corresponding to the target book identification in the content information comprised in the current topic; the relevant information may also be the information related to the recommended book that is obtained from other information sources than the current topic. For example, the content information associated with the recommended book within other topics (posts, replies, discussion content associated with the recommended book within other topics), an excerpt fragment of the recommended book (an introduction, several paragraphs of a prologue, etc.), book review information of the recommended book (from an authoritative user or other users in a book reading application), recommendation information of the recommended book (from the authoritative user or other users within the book reading application), etc.

In this embodiment, the relevant information may be displayed within a predetermined area of the first page. A subarea for displaying the relevant information may be provided in the first page, and the position of the subarea may be flexibly set according to implementation requirements, which is not specifically limited in the embodiment of the present application.

The book recommendation method according to the embodiment of the present application has been preliminarily described above by the embodiment in which the first book identification and the related information are displayed in the first page. Hereinafter, the solution of the present application will be further described in detail by the embodiments in which the first book identification and the related information are displayed in a second page independent of the display of the first page.

Referring to FIG. 3, the book recommendation method according to this embodiment may include the following steps:

Step S301, displaying a first page corresponding to the current topic, wherein the first page includes a book recommendation bar.

In this embodiment, based on an interactive topic function in the book reading application, a user may create and initiate a topic on a certain topic under the interactive topic function, and other users can join the topic for topic discussion. Under the interactive topic function page, a list including all topics may be displayed, and the user may enter the topic page of a topic by clicking any topic.

In this embodiment, the current topic refers to a topic currently entered by the user, and the first page refers to a graphical user interface corresponding to the current topic. The first page may be generated by a client device and displayed to a user on a display screen of the client device.

Specifically, the subject content of the current topic may be displayed in the first page through text, for example, “Book shortage! Please recommend a novel of category XX”. “If XX is possible, which one would you want”, etc. Corresponding to the subject content, content information replied by a user who participates in the topic is displayed in the first page through text. For example, the content information may be a title of the recommended book replied by the user, a comment on the book, a discussion on the content of the book, etc.

In this embodiment, a book recommendation bar is further displayed in the first page, and the book recommendation bar is configured for showing a recommended book to the user. Specifically, the basic information corresponding to several recommended books may be displayed within the book recommendation bar, so that the user may generally know what the recommended books are. For example, the basic information of a recommended books may be a cover thumbnail, a title, etc. of the recommended book. In addition, the book recommendation bar may also be set as an interactable object, and when the book recommendation bar is triggered by an input operation, a second page described later in the embodiments of the present application can be correspondingly entered. A specific implementation of the book recommendation bar may be a floating window, a page control, etc. and a specific input operation for triggering the book recommendation bar may be correspondingly set according to implementation requirements, for example, the input operation may be clicking or sliding, etc.

In this embodiment, the recommended books displayed in the book recommendation bar can be determined by any relevant recommendation algorithm, which will not be specifically limited in the embodiments of the present application. Through any recommendation algorithm, at least one recommended book associated with the current topic can be determined. For example, if the subject and content of the current topic is about discussion of a book of category XX, the book of category XX is determined as the recommended book described in this embodiment by any relevant recommendation algorithm. It can be understood that, in order to further reflect the relevance between the recommended book and the current topic, when a relevant recommendation algorithm is used, relevant data of all users participating in the current topic, such as historical recommendation data and historical reading data, may be used.

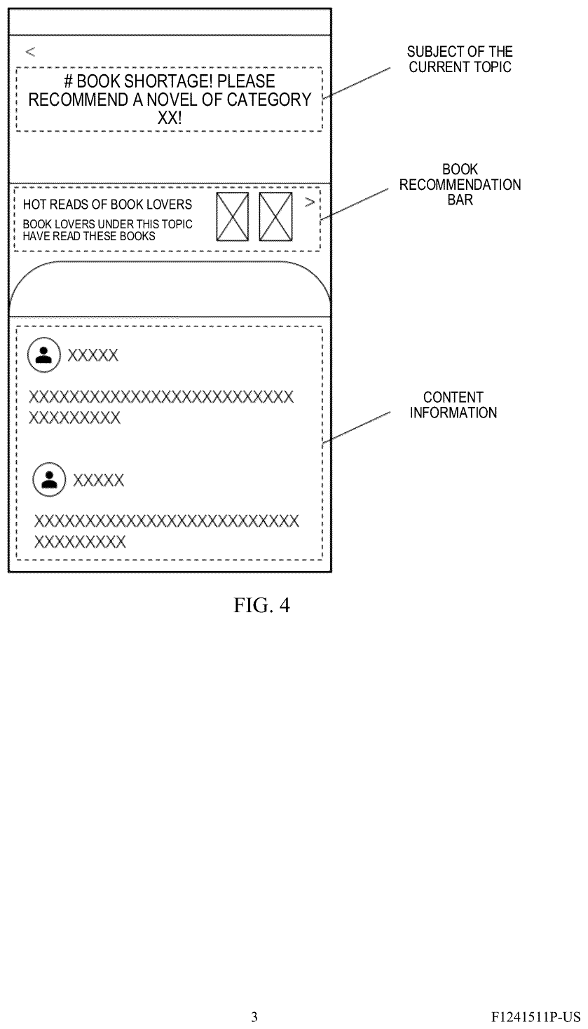

FIG. 4 illustrates a specific example of the first page. The upper part of the first page is displayed with the subject of the current topic; the lower part of the first page is displayed with the content information published by the user participating in the current topic; and the middle part of the first page is displayed with a book recommendation bar. The book recommendation bar is displayed with a text for guiding the user (such as “Hot reads of book lovers”) and the cover thumbnail of a recommended book.

Step S302, in response to a first triggering operation acting on a book recommendation bar, displaying the second page; and displaying the at least one first book identification corresponding to the at least one recommended book in the second page.

In this embodiment, the user may perform an input operation on the book recommendation bar based on the operation intention of selecting the book recommendation bar, which is referred to as a first triggering operation in this embodiment. In response to the first triggering operation, a page displaying the detailed information of the recommended book (referred to as a second page in this embodiment) is entered.

Specifically, a book identification is further displayed in the second page. In this embodiment, the book identification displayed in the second page is referred to as a first book identification. On the second page, each of the first book identifications corresponds to one recommended book. When there are more than one recommended books, the plurality of first book identifications are arranged and displayed in the second page according to a certain order. According to the size of the area in a second page for displaying the first book identifications, all of the plurality of the first book identifications may be displayed or only a part of the first book identifications may be displayed. When only a part of the first book identifications is displayed, which ones of the first book identifications are specifically displayed may be correspondingly controlled in response to the sliding operation on the area for displaying the first book identification.

In this embodiment, the first book identification has two purposes including displaying the recommended book and providing the recommended book to the user for selection. In order to realize the display purpose, a specific display form for the first book identification may be displaying a cover thumbnail of the corresponding recommended book. In addition, in order to further clarify the display, the title of the recommended book may also be displayed at the same time. In order to realize selection by the user, the first book identification is set as an interactable object, and the user may perform an input operation on the first book identification which is intended to be selected, so as to select the first book identification.

Step S303: determining a target book identification according to a predetermined rule or in response to a second triggering operation acting on any of the first book identifications.

In this embodiment, one of the first book identifications displayed in the second page is determined as the target book identification, and the target book identification is configured for determining the content information matching the target book identification specifically displayed in the second page.

In some embodiments, the target book identification may be determined according to a predetermined rule when the user has just entered the second page or the user has not input any operation on the first book identification. For example, based on the manner in which the first book identifications are sequentially arranged and displayed, the first book identification arranged first may be used as the target book identification. During the specific implementation, the target book identification may also be determined from the first book identifications in any other feasible manner, for example, the target book identification may be randomly selected. In addition, it can be understood that, when only one first book identification is displayed in the second page, this first book identification is determined as the target book identification.

In some embodiments, the user may perform an input operation on a first book identification desired to be selected on the second page, and in this embodiment, the input operation of the user acting on the first book identification is referred to as a second triggering operation. In response to the second triggering operation, a first book identification on which the second triggering operation is acted is determined as the target book identification. Specifically, the second triggering operation may be an operation such as clicking, double clicking, long pressing or double pressing acted on the first book identification. In addition, based on the manner of sequentially arranging and displaying the first book identifications, the second triggering operation may also be a sliding operation on the sequentially arranged first book identifications, and through the sliding operation, the sequentially arranged first book identifications may be slid, and the first book identification at a predetermined position where the slide operation stops is determined as the target book identification. The predetermined position may be, for example, a first position close to one side of the second page.

In this embodiment, in order to clearly show the selected target book identification to the user, the target book identification may be further highlighted after being determined. A specific manner of highlighting may be one of or a combination of more of the followings: zoom-in, highlighting, flash, and skimming.

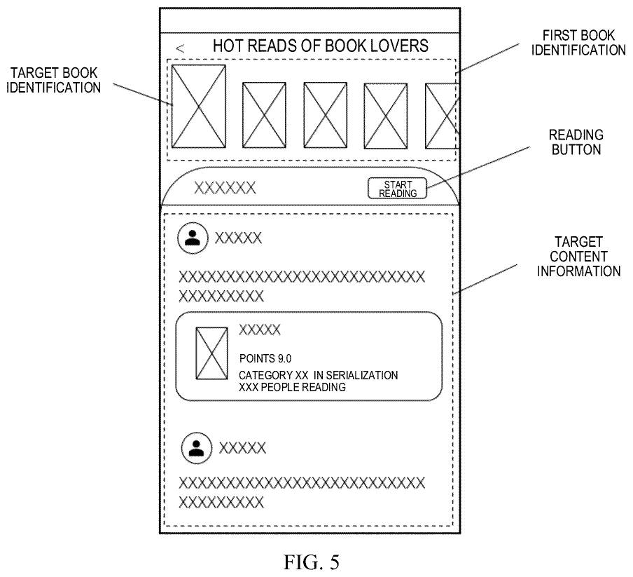

FIG. 5 illustrates a specific example of the second page, wherein the upper portion of the second page is displayed with the sequentially arranged first book identifications; the target book identification is on the top (near the first position on the left side of the second page).

At step S304, determining, from the content information comprised in the current topic, at least one piece of target content information associated with the recommended book corresponding to the target book identification, and displaying the at least part of the target content information in the second page.

In this embodiment, for the target book identification determined in the foregoing steps, the detailed information of the recommended book corresponding to the target book identification is displayed in the second page. Based on this specific application scenario of the interactive topic, the detailed information specifically refers to content information associated with a recommended book corresponding to a target book identification in all the content information comprised in the current topic, and in this embodiment, this content information is referred to as target content information. For example, the content information comprised in a current topic includes content such as comments and discussions of various users participating in the current topic for all recommended books. After the target book identification is determined through the above steps, the recommended book corresponding to the target book identification is the book A. Then, in this step, comments, discussions and the like related to the book A and published by users will be selected from all the content information comprised in the current topic as the target content information.

During specific implementation, for the determined target book identification, text matching may be performed on the text content of the content information comprised in the current topic and the text content (such as the title and content) of the recommended book corresponding to the target book identification, so as to determine the target content information. For example, a comment published by the user in the current topic on the recommended book may include the title of the recommended book, characters in the book, places in the book, a complete paragraph in the book, or the like. By means of text matching, the above contents of the recommended book appearing in the content information comprised in the current topic can be determined as the target content information associated with the recommended book. In addition, the association relationship between the content information comprised in the current topic and the recommended book corresponding to the target book identification may also be determined in any other feasible manners, and the specific way for determination is not specifically limited in this embodiment.

In this embodiment, after the target content information is determined, the target content information is displayed in the second page. Depending on the number of pieces of the target content information and the size of the area in the second page for displaying the target content information, all of a plurality of pieces of target content information may be displayed or only a part of the plurality of pieces of target content information may be displayed. When only a part of the plurality of pieces of the target content information is displayed, in response to a sliding operation on the area in which the target content information is displayed, which pieces of the target content information is specifically displayed may be correspondingly controlled.

FIG. 5 illustrates a specific example of the second page, wherein the upper portion of the second page is displayed with the sequentially arranged first book identifications; and the target book identification is on the top. The lower middle part of the second page is correspondingly displayed with target content information associated with the recommended book corresponding to the target book identification; and the target content information is specifically a comment published by a user participating in the current topic and related to the recommended book. In the second page, by showing comments of other users in the current topic for the recommended book, the currently browsing user may know the reason why other users in the current topic recommended the recommended book, the characteristics of the recommended book, etc. so that the user may learn more relevant information about the recommended book, thereby determining whether the recommended book meets his own reading requirement. When the user considers that the current recommended book does not meet his own reading requirement, another first book identification in the second page may be selected, and accordingly, after the new target book identification is determined by the foregoing Step 203, the target content information associated with the recommended book corresponding to the new target book identification is displayed for the user to select.

In some embodiments, a reading button may further be displayed in the second page, and the reading button is configured for jumping, upon being triggered, to the reading page or the transaction page of the recommended book corresponding to the target book identification. With reference to FIG. 5, when a user determines, by target content information displayed in a second page, that the recommended book meets his own reading requirement, the user may enter the reading page of the recommended book by clicking a reading button; when the reading permission of the recommended book needs to be obtained by payment, the user may click the reading button to enter the transaction page of the recommended book for subsequent transaction processing.

As an alternative embodiment, in the content information comprised in the current topic displayed in the first page, at least part of the content information carries the second book identification. In order to distinguish it from the first book identification in the foregoing embodiment, the book identification carried by the content information is referred to as second book identification in this embodiment.

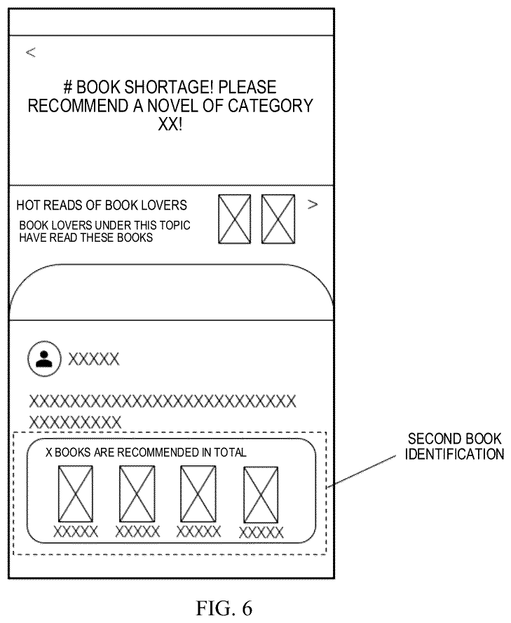

Specifically, for any one piece of the content information, the second book identification carried therein is determined according to an operation historically related to a book by a user who publishes the content information within a book reading application, for example, it may be a book historically recommended by the user, or a book locally uploaded by the user historically. As an example, for a piece of content information published by a user X within a current topic, if the user X recommends four books in total in a book reading application, a second book identification is generated for each of the four books and then added to the content information published by the user, and a specific page example may be as shown in FIG. 6.

Similar to the first book identification, the second book identification may also have two purposes: displaying a recommended book and being provided to a user for selection. The second book identification may be displayed as a cover thumbnail, cover thumbnail +title, etc. of the corresponding recommended book. The second book identification is set to be an interactable object. A user may input an operation on any of the second book identifications. In response to the operation on a second book identification, the user may jump to a reading page of a recommended book corresponding to the second book identification for reading, or jump to a transaction page for payment to obtain the reading permission.

In this embodiment, the recommended book may also be determined by the following ways:

Step one, at least one book to be selected is determined according to the second book identification.

In this embodiment, all the content information carrying the second book identifications is determined according to all the content information comprised in the current topic, and all the books corresponding to the second book identifications carried by the content information are determined as the books to be selected. For example, in the current topic, there are two pieces of content information replied by users in total that carry the second book identifications, which are the content information published by the user X and carrying the second book identifications corresponding to books A and B, and the content information published by the user Y and carrying the second book identification corresponding to the book C, and then the books A, B and C are determined as the books to be selected accordingly.

Step two, according to historical reading data of all users participating in the current topic, for each of the books to be selected, the number of users who have read the book to be selected is determined as the number of readers within the topic of the books to be selected.

In this embodiment, historical reading data of all users participating in the current topic is obtained, and the historical reading data may reflect a book which has been read historically by all users participating in the current topic. The historical reading data may be stored locally on the client device or obtained from a server.

During a specific implementation, the obtained historical reading data is matched with the book to be selected determined in the above steps, and if they are matched, the books to be selected that have been read by those users historically participating in the current topic will be determined. For each book to be selected, the number of users who have read the book to be selected and participate in the current topic is determined as the number of readers within the topic corresponding to the book to be selected. For example, for the books to be selected A, B and C determined in the above steps, according to historical reading data of all users participating in the current topic, it is determined that 8 users have ever read the book to be selected A, 6 users have ever read the book to be selected B and 3 users have read the book to be selected C, then the number of readers of the book to be selected A within the topic is correspondingly determined to be 8, the number of readers of the book to be selected B within the topic is determined to be 6, and the number of readers of the book to be selected C within the topic is determined to be 3.

Step three, the recommended book is determined according to the number of readers within the topic.

In this embodiment, the recommended books are determined according to the number of readers within the topic corresponding to each book to be selected. Specifically, for a book to be selected, when the number of readers within a topic is larger, it indicates that there are a lot of users who have read the book to be selected and have participated in the discussion of the current topic, and thus the book to be selected is more likely met the reading requirements of respective users participating in the current topic. Based on this, a threshold of the number of readers within the topic can be correspondingly set, and when the number of readers within the topic corresponding to a book to be selected exceeds the threshold, the book to be selected can be determined as the recommended book. For example, the above threshold may be set as 2. When the number of readers in a topic corresponding to any book to be selected exceeds 2, the book to be selected may be determined as the recommended book. In specific implementation, the foregoing threshold may be set correspondingly according to specific implementation requirements, which will not be specifically limited in the embodiment of the present application.

It should be noted that, in this embodiment and other embodiments of the present application, all data related to the number of readers, historical reading data, and the like are obtained after being authorized by the user, or are initiatively uploaded by the user.

According to the method of the embodiment, based on content information carrying a second book identification in a current topic, books recommended or uploaded by all users participating in the current topic can be taken as books to be selected. According to historical reading data of all users participating in the current topic, the number of readers within a topic of each book to be selected can be determined; the recommendation degree of the book to be selected within the current topic is reflected by the number of readers within the topic; and then recommended books are determined from the books to be selected based on the number of readers within the topic. In this way, the determined recommended book may meet the reading requirement of the user participating in the current topic to a great extent, thereby effectively improving the book recommendation efficiency.

As an optional embodiment, on the basis of the foregoing embodiment in which the content information carries the second book identification, when the first page is displayed, for the content information carrying the second book identification, the second book identification can be specifically displayed in different manners according to the number of carried second book identifications.

In this embodiment, for any of pieces of content information in the first page, in response to determining that the number of second book identifications carried in the piece of content information is greater than one, the cover thumbnails and titles of recommended books corresponding to the second book identifications are displayed. Reference is made to FIG. 6. FIG. 6 is a specific example of the first page. In the example, the content information carries four second book identifications. Considering the size of the area for displaying the second book identifications and the requirement of clear display, the four second book identifications can be arranged and displayed, and each second book identification is displayed only with a cover thumbnail and title of a corresponding recommended book.

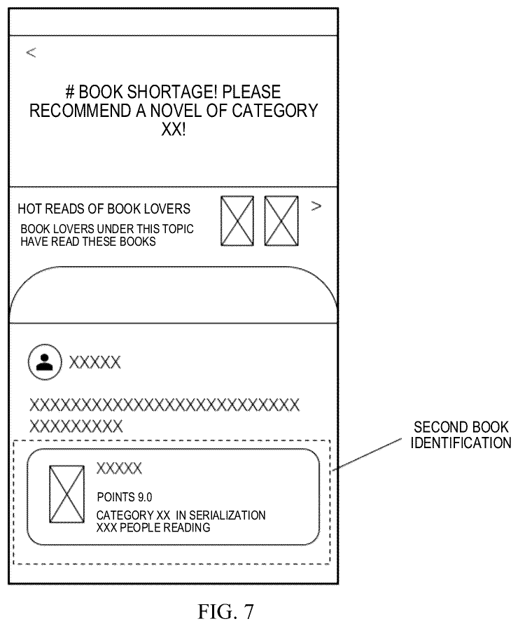

In this embodiment, for any one piece of the content information, in response to determining that the number of the second book identifications carried in the piece of content information is one, displaying a cover thumbnail, a title and relevant information of a recommended book corresponding to the second book identification; wherein the relevant information comprises at least one of the following: a category, a rating, a serialization status and the number of readers of the recommended book corresponding to the second book identification. Referring to FIG. 7, FIG. 7 is a specific example of the first page. In the example, the content information carries one second book identification. Since there is sufficient display space, in addition to displaying the cover thumbnail and title of the recommended book corresponding to the second book identification, it is possible to further display other relevant information of the recommended book, such as category, a rating, a serialization status and the number of readers, etc.

In addition, similar to the first page, when the second page is displayed, since the target content information displayed within the second page comes from the content information within the first page, the target content information may also be displayed with the second book identification carried therein in the above manner, and for the specific effect, reference can be made to the example of the page shown in FIG. 4.

According to the method of the present embodiment, based on the size of an area for displaying a second book identification in the first page and a display requirement by the second book identification itself, the display can be correspondingly adjusted according to the number of second book identifications, thereby further improving the display amount and display efficiency of relevant information of the book.

As an optional embodiment, on the basis of the foregoing embodiment in which the content information carries the second book identification, when the second page is displayed, for the first book identifications arranged and displayed in the second page, the arrangement order of these first book identifications can be specifically determined by the number of readers within the topics of recommended books corresponding to these first book identifications.

Specifically, since the recommended books corresponding to the first book identifications are determined to be selected books, the recommended books respectively correspond to the numbers of readers within the topic. The first book identification may be sorted and displayed according to the numbers of readers within the topic, based on the property that the number of readers within the topic can reflect the recommendation degree of the recommended book within the current topic. For example, the first book identifications may be arranged and displayed sequentially in a descending order in terms of the number of readers within the topic.

Further, the first book identifications are displayed sequentially in a descending order in terms of the number of readers within the topic. When determining the target book identification, the first book identification on the top may be taken as the target book identification. In this way, the recommended book with the highest recommendation degree in the current topic can be taken as the target book identification to display subsequent target content information, and the book recommendation efficiency can be improved.

As an optional embodiment, on the basis of the foregoing embodiment in which the content information carries the second book identification, the target content information associated with the recommended book corresponding to the target book identification can be determined from the content information comprised in the current topic according to the second book identification.

Specifically, for any one piece of the content information, in response to determining that any of the second book identifications carried in the piece of content information is in consistent with the target book identification, the piece of content information is determined as the target content information.

In this embodiment, since the second book identification has functions and implementations similar to those of the target book identification, the relevance between the content information and the recommended book corresponding to the target book identification can be determined correspondingly by determining whether the second book identification is in consistent with the target book identification. For any one piece of the content information, if the second book identification carried in the content information is in consistent with the target book identification, the content information is more likely to be the related comment content for the recommended book, and then the content information can be correspondingly determined as the target content information associated with the recommended book. By means of determining the target content information according to the second book identification and the target book identification, the processing is simple and quick, and the execution efficiency of the solution as a whole can be improved.

As an optional embodiment, in the step of displaying at least a part of the target content information in the second page, a method for controlling a display order of the target content information may be further included. Specifically, the method for controlling the display order of the target content information includes: for any one piece of the target content information, determining a total number of reading times and a total reading duration of a user who publishes the target content information in reading a recommended book corresponding to the target book identification, and determining a display priority of the target content information according to the total number of reading times and the total reading duration; controlling a display order of the target content information according to the display priority.

In the present embodiment, considering the recommended book corresponding to the target book identification, if a user reads the recommended book more frequently, the target content information published by a user who has read more frequently is likely to contain more or more detailed comments with regard to the recommended book. The target content information will correspondingly enable the user to obtain more or more detailed information about the recommended book, which can improve book recommendation efficiency. Based on the above idea, in this embodiment, the display location of the target content information published by the user who has read more frequently is set to be closer to the front position. Specifically, the total number of reading times and the total reading duration in reading the recommended book are used to reflect more frequent reading of the recommended book by the user.

In this embodiment, for any one piece of the target content information, the total number of reading times and the total reading duration of the user who publishes the target content information in reading a recommended book corresponding to a target book identification are obtained, and the total number of reading times and the total reading duration can be obtained from local storage of a client device or from a server.

During specific implementation, the display priority of the target content information is calculated and obtained according to the obtained total number of reading times and total reading duration. Since both the total number of reading times and the total reading duration are data, the content of which is a numerical value, the display priority may be calculated by means of weighted sum. The weight values respectively corresponding to the total number of reading times and the total reading duration may be determined according to implementation requirements, which is not specifically limited in this embodiment.

After a corresponding display priority is calculated for each piece of target content information, a display order of the target content information may be set according to the display priorities. Specifically, sorting may be performed according to numerical values of display priorities, and target content information is controlled to be sequentially displayed in a descending order.

According to the method of the present embodiment, the total number of reading times and the total reading duration of a user in reading the recommended book reflect frequent reading of the recommended book by the user, and target content information published by the user who has reads the book frequently is preferentially displayed, so that the user can preferentially view the topic content with a higher recommendation degree, thereby improving the book recommendation efficiency.

As an optional embodiment, at least part of the target content information displayed in the second page may further carry a topic jumping identification; and the topic jumping identification is configured to jump, upon being triggered, to a target topic in which a user publishing the target content information participates.

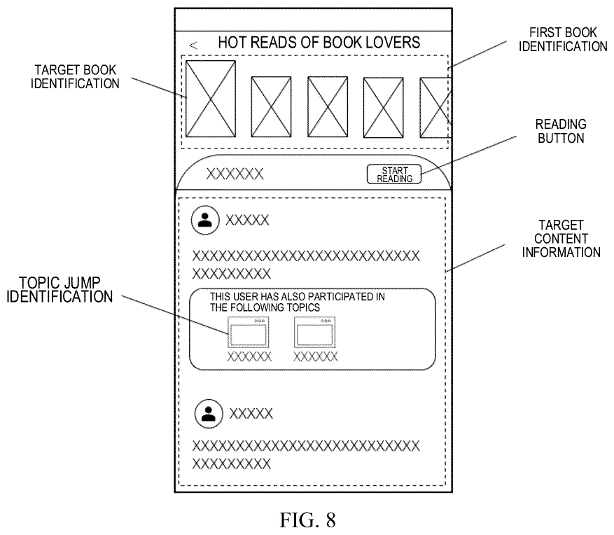

In this embodiment, considering that a user participating in the current topic participates in other topics as well, relevant book recommendation information may also be provided, so that the user can find a book that meets his own reading requirement. In this embodiment, the target content information may further carry a topic jumping identification, and the topic jumping identification is set to be an interactable object. When the user performs an input operation to trigger the topic jumping identification, a target topic to which the topic jumping identification points may be jumped to. Specifically, for any one piece of the target content information, other topics that the user (who publishes the target content information in the book reading application) has participated in may be determined according to historical operation data of the user, and access addresses of these other topics may be determined correspondingly. Correspondingly, the topic jumping identification is added to the target content information and then displayed, wherein a topic jumping identification points to an access address of a corresponding target topic; and when the user inputs an operation to trigger the topic jumping identification, the user can access the address of the target topic and jump to the page of the target topic. Referring to FIG. 8, a specific example of the second page displayed with the topic jumping identification is illustrated, wherein the target content information carries two topic jumping identifications, and the user selects any of the topic jump identifications, and then the page of the selected target topic is jumped to for further obtaining other book recommendation information.

The method of the present embodiment enables a user to conveniently and quickly jump to a page of another relevant topic in which a user within the current topic participates through a topic jumping identification carried in target content information displayed in a second page, so as to further obtain book recommendation information, thereby effectively improving the book recommendation efficiency.

It can be seen from the above embodiments that, in the book recommendation method according to the embodiments of the present application, the book recommendation bar merely serves as an entry to guide the user to enter the second page, and target content information matching the recommended book can be displayed in the second page; and the displayed target content information is associated with the recommended book, so that the user may know, according to the displayed target content information, content associated with the recommended book provided by other users in the current topic. The method of the present application can provide more relevant information about the book to the user, which effectively improves the book recommendation efficiency.

It should be noted that, specific content and specific quantity of features presented in the illustration and examples provided in the foregoing embodiments are merely used as examples, which are not intended to limit the corresponding features in various embodiments of the present application.

It should be noted that the methods according to the embodiment of the present application may be executed by a single device, such as a computer or a server. The methods in this embodiment may also be applied to a distributed scenario in which a plurality of devices cooperate with each other to complete the method. In a distributed scenario, one of the plurality of devices may execute only one or more steps in the method according to the embodiment of the present application, and the plurality of devices may interact with each other to implement the method.

It should be noted that, some embodiments of the present application are described above, and other embodiments are within the scope of the appended claims. In some cases, the actions or steps recited in the claims may be performed in a different order than in the embodiments described above, which may still achieve desirable results. In addition, to realize desirable results, the processes depicted in the drawings do not necessarily to be in the particular order as illustrated or in a sequential order. In certain embodiments, multitasking and parallel processing may also be possible or may be advantageous.

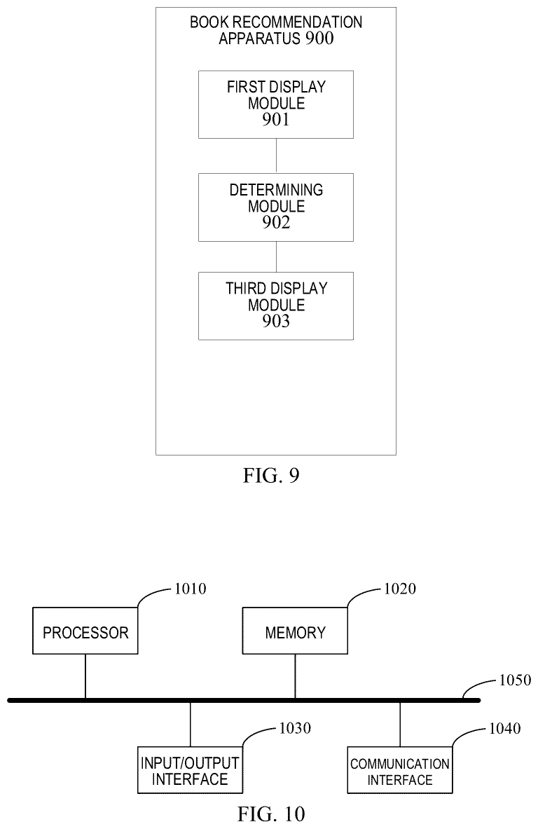

Based on the same technical concept, an embodiment of the present application further provides a book recommendation apparatus. Referring to FIG. 9, the book recommendation apparatus 900 includes:
a first display module 901 configured to display at least one first book identification corresponding to at least one recommended book within a target page related to a current topic, wherein the recommended book is associated with the current topic.
a determining module 902 configured to determine a target book identification according to a predetermined rule or in response to a triggering operation acting on any of the first book identifications;
a second display module 903 configured to determine at least one piece of relevant information related to a recommended book corresponding to the target book identification, and display at least part of the relevant information in the target page.

As an optional embodiment, the target page is a first page corresponding to the current topic, and the first page is configured for displaying content information comprised in the current topic; the second display module 903 is configured to display at least part of the related information in a predetermined area of the first page.

As an optional embodiment, the current topic corresponds to a first page for displaying content information comprised in the current topic; and the target page is a second page displayed independently of the first page. The first display module 901 is configured to display the first page, the first page including a book recommendation bar; in response to a first triggering operation acting on the book recommendation bar, display the second page; and display the at least one first book identification corresponding to the at least one recommended book in the second page.

As an optional embodiment, the second display module 903 is configured to determine, from the content information comprised in the current topic, at least one piece of target content information associated with the recommended book corresponding to the target book identification, and use the target content information as the relevant information.

As an optional embodiment, the second display module 903 is configured to obtain at least one of the following as the relevant information: content information associated with the recommended book corresponding to the target book identification within other topics; an excerpt fragment of the recommended book corresponding to the target book identification; book review information of the recommended book corresponding to the target book identification; and recommendation information of the recommended book corresponding to the target book identification.

As an optional embodiment, at least part of the content information carries a second book identification; the first display module 901 is specifically configured to determine at least one book to be selected according to the second book identification; determine a relevance between the book to be selected and the current topic; and determine the recommended book according to the relevance.

As an optional embodiment, the third display module 903 is specifically configured to, for any one piece of the content information, in response to determining that any of the second book identifications carried in the piece of content information is in consistent with the target book identification, determine the piece of content information as the target content information.

As an optional embodiment, the first display module 901 is specifically configured to, for any of pieces of the content information, in response to determining that the number of the second book identifications carried in the piece of content information is one, display a cover thumbnail, a title and relevant information of a recommended book corresponding to the second book identification; wherein the relevant information comprises at least one of the following: a category, a rating, a serialization status and the number of readers of the recommended book corresponding to the second book identification; and for any of pieces of the content information, in response to determining that the number of second book identifications carried in the piece of content information is greater than one, display cover thumbnails and titles of recommended books corresponding to the second book identifications.

As an optional embodiment, at least part of the target content information carries a topic jumping identification; and the topic jumping identification is configured to jump, upon being triggered, to a target topic in which a user publishing the target content information participates.

As an optional embodiment, the target page is further displayed with a reading button; and the reading button is configured to jump, upon being triggered, to a reading page or a transaction page of the recommended book corresponding to the target book identification.

For ease of description, the foregoing apparatus is described by dividing functions into various modules for separate description. Definitely, when the present application is implemented, functions of each module may be implemented in one or more pieces of software and/or hardware.

The device of the described embodiment is used for realizing the corresponding book recommendation method in any of the described embodiments, and has the beneficial effect of the corresponding method embodiment, which will not be repeated here.

Based on the same technical concept, the embodiments of the present application further provide an electronic device, comprising a memory, a processor and a computer program stored in the memory and capable of running on the processor, wherein when executing the program, the processor realizes the book recommendation method as described in any of the above embodiments.

FIG. 10 is a schematic structural diagram of more specific hardware of an electronic device according to an embodiment of the present disclosure. The device may include: a processor 1010, a memory 1020, an input/output interface 1030, a communications interface 1040, and a bus 1050. The processor 1010, the memory 1020, the input/output interface 1030, and the communications interface 1040 are connected to each other through the bus 1050 to enable communication within the device.

The processor 1010 may be implemented by using a universal CPU (Central Processing Unit), a microprocessor, an application specific integrated circuit (ASIC), or one or more integrated circuits, and it is configured to execute a relevant program, so as to implement the technical solutions provided in the embodiments of the specification.

The memory 1020 may be implemented in the form of a ROM (Read Only Memory), a RAM (Random Access Memory), a static storage device, and a dynamic storage device. The memory 1020 may store an operating system and other application programs. When the technical solutions provided in the embodiments of the present disclosure are implemented by software or firmware, related program codes are stored in the memory 1020 and called and executed by the processor 1010.

The input/output interface 1030 is configured to connect to an input/output module to input and output information. The input/output module may be configured in a device (not shown in the drawing) as a component, and may also be externally connected to the device to provide corresponding functions. The input device may include a keyboard, a mouse, a touch screen, a microphone, various sensors, and the like, and the output device may include a display, a speaker, a vibrator, an indicator lamp, and the like.

The communications interface 1040 is configured to connect to a communications module (not shown in the drawing), so as to implement communication and interaction between this device and another device. The communication module may implement communication in a wired manner (such as a USB and a network cable), and may also implement communication in a wireless manner (such as a mobile network, WIFI, and Bluetooth).

The bus 1050 may include a pathway that may enable information transmission between various components of the device, such as, the processor 1010, the memory 1020, the input/output interface 1030, and the communication interface 1040.

It should be noted that, although the foregoing device only shows the processor 1010, the memory 1020, the input/output interface 1030, the communications interface 1040, and the bus 1050, in a specific implementation process, the device can further include other components necessary for normal operation. In addition, those skilled in the art may understand that the above device may also include only components necessary for implementing solutions of embodiments of the present specification, and does not necessarily include all components shown in the drawing.

The electronic device in the described embodiment is configured for realizing the corresponding book recommendation method in any of the described embodiments, which has the beneficial effect of the corresponding method embodiment, which will not be repeated here.

Based on the same technical concept, the embodiments of the present application further provide a non-transitory computer readable storage medium. The non-transitory computer readable storage medium stores a computer instruction. The computer instruction is configured for enabling the computer to execute the book recommendation method as described in any of the above embodiments.

The computer readable media of this embodiment, including both persistent and non-persistent, removable and non-removable media, may be used by any method or technology for storage of information. The information may be computer readable instructions, data structures, modules of a program, or other data. Examples of computer storage media include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disc read-only memory (CD-ROM), digital versatile discs (DVD) or other optical storage, magnetic cassettes. Magnetic tape magnetic disk storage or other magnetic storage devices, or any other non-transmission medium, and the computer storage media may be configured to store information that may be accessed by a computing device.

The computer instruction stored in the storage medium of the above embodiment is configured for enabling the computer to execute the book recommendation method as described in any of the described embodiments, and has the beneficial effect of the corresponding method embodiment, which will not be repeated here.

It should be noted that, unless otherwise defined, technical terms or scientific terms used in the embodiments of the present application should have a meaning commonly understood by those skilled in the art. The terms “first”, “second”, and the like used in the embodiments of the present application do not indicate any order, quantity, or importance, but are only used to distinguish different components. Words of “comprising” or “including” and the like refer to that the element or item before the word appears to encompass the elements or items and equivalents thereof listed after the word without excluding other elements or items. Words such as “connected” or “connected” are not limited to physical or mechanical connections, but may include electrical connections, whether direct or indirect. The articles “a” or “an” preceding an element do not exclude the presence of a plurality of such elements.

Although the spirit and principle of the present application have been described with reference to several specific implementations, it should be understood that the present application is not limited to the disclosed specific implementations, and the division of aspects does not mean that features in these aspects cannot be combined for beneficial use, and the division is only for convenience of description. The present application is intended to cover various modifications and equivalent arrangements included within the spirit and scope of the appended claims. The scope of the appended claims conforms the broadest interpretation so as to encompass all such modifications and equivalent structures and functions.

1-13. (canceled)

14. A method for book recommendation, wherein the method comprises:
displaying at least one first book identification corresponding to at least one recommended book within a target page related to a current topic, wherein the recommended book is associated with the current topic;
determining a target book identification according to a predetermined rule or in response to a triggering operation acting on any of the first book identifications; and
determining at least one piece of relevant information related to a recommended book corresponding to the target book identification, and displaying at least part of the relevant information in the target page.

15. The method of claim 14, wherein the target page is a first page corresponding to the current topic, and the first page is configured for displaying content information comprised in the current topic;
displaying at least part of the relevant information in the target page comprises:
displaying at least part of the relevant information within a predetermined area of the first page.

16. The method of claim 14, wherein the current topic corresponds to a first page for displaying content information comprised in the current topic; the target page is a second page displayed independently of the first page;
displaying the at least one first book identification corresponding to the at least one recommended book within the target page related to the current topic, comprises:
displaying the first page, the first page comprising a book recommendation bar;
in response to a first triggering operation acting on the book recommendation bar, displaying the second page; and displaying the at least one first book identification corresponding to the at least one recommended book in the second page.

17. The method of claim 15, wherein determining the at least one piece of relevant information related to the recommended book corresponding to the target book identification comprises:
determining, from the content information comprised in the current topic, at least one piece of target content information associated with the recommended book corresponding to the target book identification, and using the target content information as the relevant information.

18. The method of claim 17, wherein determining at least one piece of the relevant information related to the recommended book corresponding to the target book identification further comprises:
obtaining at least one of the following as the relevant information:
content information associated with the recommended book corresponding to the target book identification within other topics;
an excerpt fragment of the recommended book corresponding to the target book identification;
book review information of the recommended book corresponding to the target book identification; and
recommendation information of the recommended book corresponding to the target book identification.

19. The method of claim 17, wherein at least part of the content information carries a second book identification;
the method further comprises determining the recommended book through:
determining at least one book to be selected according to the second book identification;
determining a relevance between the book to be selected and a current topic; and
determining the recommended book according to the relevance.

20. The method of claim 19, wherein determining, from content information comprised in the current topic, at least one piece of target content information associated with the recommended book corresponding to the target book identification comprises:
for any of pieces of the content information, in response to determining that any of the second book identifications carried in the piece of content information is in consistent with the target book identification, determining the piece of content information as the target content information.

21. The method of claim 16, wherein displaying the first page comprises:
for any of pieces of the content information, in response to determining that the number of the second book identifications carried in the piece of content information is one, displaying a cover thumbnail, a title and relevant information of a recommended book corresponding to the second book identification; wherein the relevant information comprises at least one of: a category, a rating, a serialization status and a number of readers of the recommended book corresponding to the second book identification; and
for any of pieces of the content information, in response to determining that a number of the second book identifications carried in the piece of content information is greater than one, displaying cover thumbnails and titles of recommended books corresponding to the second book identifications.

22. The method of claim 17, wherein at least part of the target content information carries a topic jumping identification; and the topic jumping identification is configured to jump, upon being triggered, to a target topic in which a user publishing the target content information participates.

23. The method of claim 14, wherein a reading button is further displayed in the target page; and the reading button is configured to jump, upon being triggered, to a reading page or a transaction page of the recommended book corresponding to the target book identification.

24. An electronic device, comprising a memory, a processor, and a computer program stored on the memory and executable on the processor, wherein when executing the program, the processor implements a method for book recommendation comprising:
displaying at least one first book identification corresponding to at least one recommended book within a target page related to a current topic, wherein the recommended book is associated with the current topic;
determining a target book identification according to a predetermined rule or in response to a triggering operation acting on any of the first book identifications; and
determining at least one piece of relevant information related to a recommended book corresponding to the target book identification, and displaying at least part of the relevant information in the target page.

25. The electronic device of claim 24, wherein the target page is a first page corresponding to the current topic, and the first page is configured for displaying content information comprised in the current topic;
displaying at least part of the relevant information in the target page comprises:
displaying at least part of the relevant information within a predetermined area of the first page.

26. The electronic device of claim 24, wherein the current topic corresponds to a first page for displaying content information comprised in the current topic; the target page is a second page displayed independently of the first page;
displaying the at least one first book identification corresponding to the at least one recommended book within the target page related to the current topic, comprises:
displaying the first page, the first page comprising a book recommendation bar;
in response to a first triggering operation acting on the book recommendation bar, displaying the second page; and displaying the at least one first book identification corresponding to the at least one recommended book in the second page.

27. The electronic device of claim 25, wherein determining the at least one piece of relevant information related to the recommended book corresponding to the target book identification comprises:
determining, from the content information comprised in the current topic, at least one piece of target content information associated with the recommended book corresponding to the target book identification, and using the target content information as the relevant information.

28. The electronic device of claim 27, wherein determining at least one piece of the relevant information related to the recommended book corresponding to the target book identification further comprises:
obtaining at least one of the following as the relevant information:
content information associated with the recommended book corresponding to the target book identification within other topics;
an excerpt fragment of the recommended book corresponding to the target book identification;
book review information of the recommended book corresponding to the target book identification; and
recommendation information of the recommended book corresponding to the target book identification.

29. The electronic device of claim 27, wherein at least part of the content information carries a second book identification;
the method further comprises determining the recommended book through:
determining at least one book to be selected according to the second book identification;
determining a relevance between the book to be selected and a current topic; and
determining the recommended book according to the relevance.

30. The electronic device of claim 29, wherein determining, from content information comprised in the current topic, at least one piece of target content information associated with the recommended book corresponding to the target book identification comprises:
for any of pieces of the content information, in response to determining that any of the second book identifications carried in the piece of content information is in consistent with the target book identification, determining the piece of content information as the target content information.

31. The electronic device of claim 26, wherein displaying the first page comprises:
for any of pieces of the content information, in response to determining that the number of the second book identifications carried in the piece of content information is one, displaying a cover thumbnail, a title and relevant information of a recommended book corresponding to the second book identification; wherein the relevant information comprises at least one of: a category, a rating, a serialization status and a number of readers of the recommended book corresponding to the second book identification; and
for any of pieces of the content information, in response to determining that a number of the second book identifications carried in the piece of content information is greater than one, displaying cover thumbnails and titles of recommended books corresponding to the second book identifications.

32. The electronic device of claim 27, wherein at least part of the target content information carries a topic jumping identification; and the topic jumping identification is configured to jump, upon being triggered, to a target topic in which a user publishing the target content information participates.

33. A non-transitory computer readable storage medium, wherein the non-transitory computer readable storage medium stores a computer instruction, and the computer instruction is configured to cause a computer to execute a method for book recommendation comprising:
displaying at least one first book identification corresponding to at least one recommended book within a target page related to a current topic, wherein the recommended book is associated with the current topic;
determining a target book identification according to a predetermined rule or in response to a triggering operation acting on any of the first book identifications; and
determining at least one piece of relevant information related to a recommended book corresponding to the target book identification, and displaying at least part of the relevant information in the target page.
